(19) United States
(12) Patent Application Publication
(10) Pub. No.: US 2026/0044158 A1
(43) Pub. Date: Feb. 12, 2026

(54) VEHICLE FOLLOWING SYSTEM

(71) Applicant: Textron Inc., Providence, RI (US)

(72) Inventor: Preston Sering Easley, Martinez, GA (US)

(73) Assignee: Textron Inc., Providence, RI (US)

(21) Appl. No.: 18/800,314

(22) Filed: Aug. 12, 2024

(51) Int. Cl. G05D 1/695; G05D 1/22; G05D 101/20; G05D 107/17

(52) U.S. Cl. CPC G05D 1/695; G05D 1/22; G05D 2101/20; G05D 2107/17

(57) ABSTRACT

A golf vehicle following system includes a following golf vehicle. The following golf vehicle includes a driveline, a communications interface, and a sensor system configured to acquire second data. The golf vehicle system includes at least one processing circuit having at least one processor and at least one memory, the at least one memory storing instructions thereon that, when executed by the at least one processor, cause the at least one processor to: receive a request for the following golf vehicle to follow a leading golf vehicle; and control the driveline such that the following golf vehicle follows the leading golf vehicle within a specified distance based on at least one of (a) first data acquired from at least one of the communications interface or from a global positioning system or (b) the second data acquired by the sensor system.

### BACKGROUND

Golf vehicles are used to transport personnel and equipment between different areas. By way of example, a golf vehicle may transport golfers and equipment (e.g., golf bags, golf clubs, etc.) around a golf course (e.g., along a cart path, between different holes, etc.). When golf vehicles are in use (e.g., during the daytime), the golf vehicles may be parked at or near an entrance of a golf course. When golf vehicles are not in use (e.g., during the nighttime), the golf vehicles may be stored in a garage or parking area.

### SUMMARY

One embodiment relates to a golf vehicle following system. The golf vehicle following system includes following golf vehicle. The following golf vehicle includes a driveline including a prime mover, a braking system, and a steering system. The following golf vehicle includes a communications interface. The following golf vehicle includes a sensor system including one or more sensors configured to acquire second data. The golf vehicle system includes at least one processing circuit having at least one processor and at least one memory, the at least one memory storing instructions thereon that, when executed by the at least one processor, cause the at least one processor to: receive a request for the following golf vehicle to follow a leading golf vehicle; and control the driveline such that the following golf vehicle follows the leading golf vehicle within a specified distance based on at least one of (a) first data acquired from at least one of the communications interface or from a global positioning system or (b) the second data acquired by the sensor system.

Another embodiment relates to a vehicle following system. The vehicle following system includes a non-transitory computer readable media storing instructions. The instructions, when executed by one or more processors of a processing circuit, cause the processing circuit to perform operations comprising: receiving a request for a following vehicle to follow a leading golf vehicle, receiving at least one of (a) first data acquired from at least one of a communications interface or a global positioning system (GPS) or (b) second data acquired by a sensor system of the following vehicle, and controlling a driveline of the following vehicle such that the following vehicle follows the leading vehicle within a specified distance based on at least one of the first data or the second data.

Still another embodiment relates to a vehicle following system. The vehicle following system includes following vehicle. The following vehicle includes a driveline including a prime mover, a braking system, and a steering system. The following vehicle includes a communications interface. The following vehicle includes a sensor system including one or more sensors configured to acquire second data. The vehicle system includes at least one processing circuit having at least one processor and at least one memory, the at least one memory storing instructions thereon that, when executed by the at least one processor, cause the at least one processor to: receive a request for the following vehicle to follow a leading vehicle; and control the driveline such that the following vehicle follows the leading vehicle within a specified distance based on at least one of (a) first data acquired from at least one of the communications interface or from a global positioning system or (b) the second data acquired by the sensor system.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a perspective view of a leading vehicle and a following vehicle, according to an exemplary embodiment.

FIG. 5 is a flow diagram of a method of implementing control of a following vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

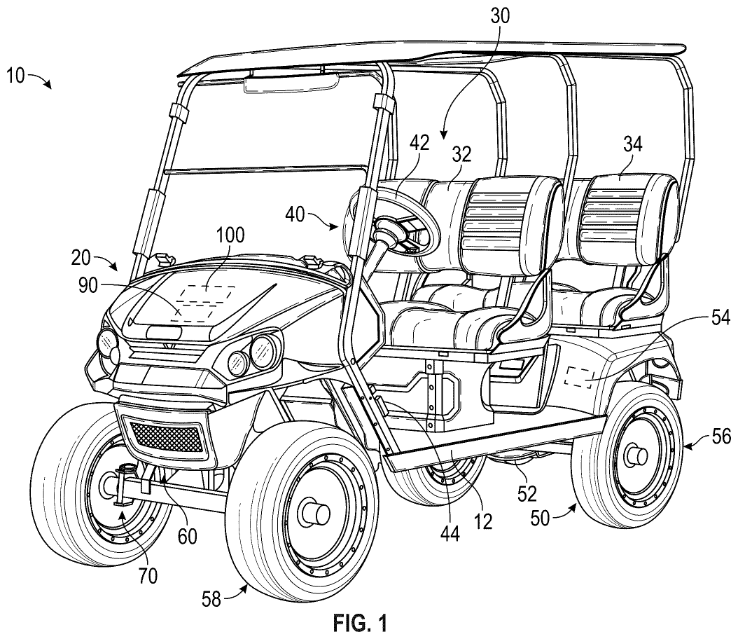

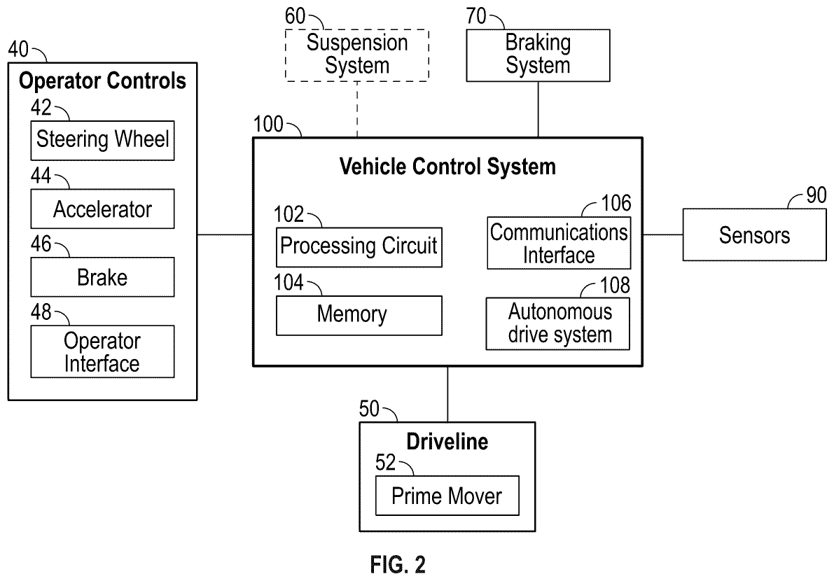

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a radar sensor, a LiDAR sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

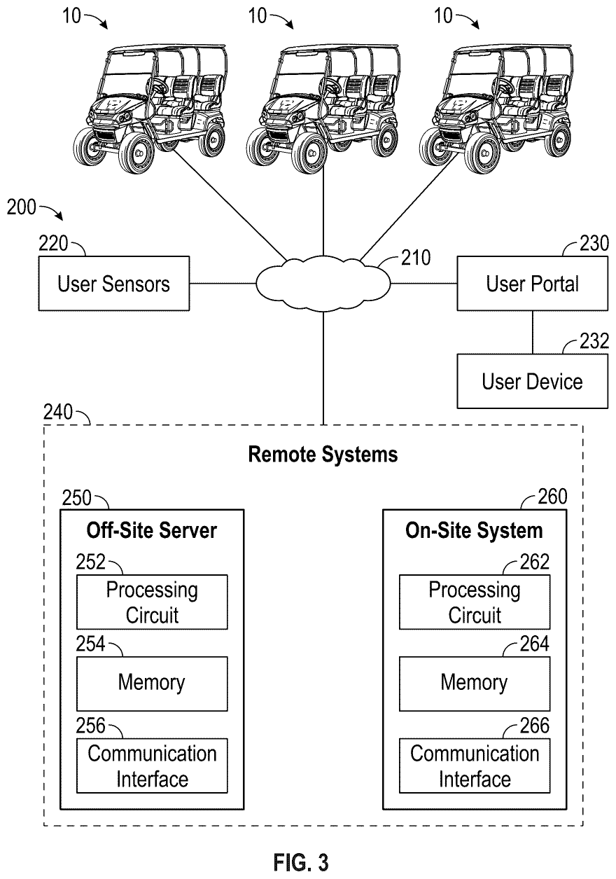

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Following System

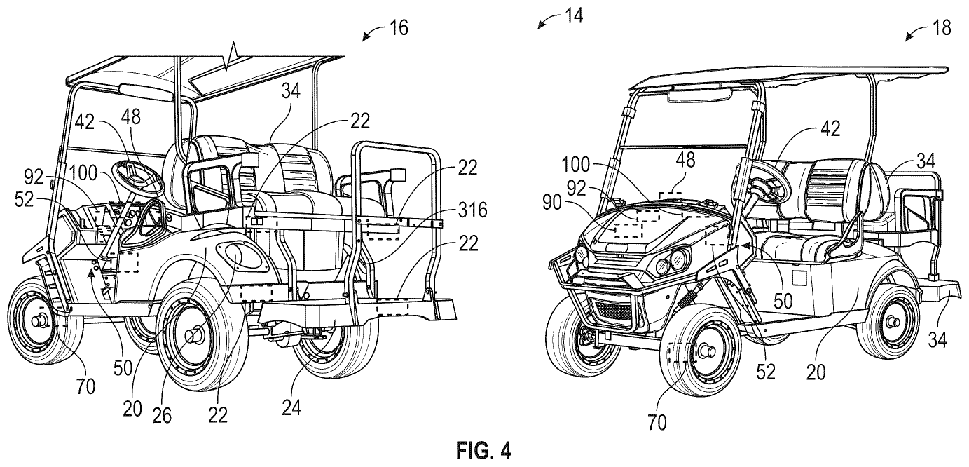

As shown in FIG. 4, a system, shown as vehicle following system 14, includes one or more vehicles 10. The one or more vehicles 10 shown in FIG. 4 are substantially similar to the vehicle 10 of FIG. 1-3 except as otherwise specified herein. Each of the vehicles 10 shown in FIG. 4 include the driveline 50. According to an example embodiment, the driveline 50 includes the prime mover 52, the braking system 70, and/or a steering system including the steering wheel 42. In some embodiments, the vehicles 10 are configured as golf vehicles. Each of the vehicles 10 shown in FIG. 4 includes the operator interface 48.

As shown in FIG. 4, the one or more vehicles 10 includes a first vehicle, shown as leading vehicle 16, and a second vehicle, shown as following vehicle 18. Certain components and systems are shown as being part of one of the leading vehicle 16 or the following vehicle 18. However, each of the leading vehicle 16 or the following vehicle 18 may include any of the components and/or systems described herein.

In an example embodiment, the leading vehicle 16 includes at least one physical identifier. The physical identifier may include, for example, one or more fiducial markers 22, taillights 26, and/or a configuration of the leading vehicle 16. The configuration of the leading vehicle 16 includes one or more of a shape of the body 20, a shape of the seating area 30 (or a portion thereof), and/or another portion of the leading vehicle 16. In some embodiments, the following vehicle 18 also includes at least one physical identifier. In some embodiments, a position of the leading vehicle 16 relative to the following vehicle 18 may be determined based on detecting the physical identifier (e.g., by one or more sensors) and correlating a size of the physical identifier to a current distance between the following vehicle 18 and the leading vehicle 16, as described in greater detail herein.

As shown in FIG. 4, the leading vehicle 16 includes one or more fiducial markers 22. Each of the fiducial markers 22 is an object (e.g., a decal, a sticker, etc.) positioned on a portion of the leading vehicle 16. The fiducial markers 22 are positioned at different locations on the leading vehicle 16. For example, the fiducial markers 22 may be variously positioned at a rear-facing side of the leading vehicle 16. As shown in FIG. 4, the one or more fiducial markers 22 are positioned (i) on the body 20 of the leading vehicle 16, (ii) on the rear row seating 34, and/or on a vehicle accessory, such as a rear floorboard assembly 24. The fiducial markers 22 are used as reference points for determining a position of the leading vehicle 16 relative to the following vehicle 18. For example, the fiducial markers 22 may be used as points of reference in a computer vision analysis process. The position of the leading vehicle 16 relative to the following vehicle 18 may be determined based on detecting the fiducial markers 22 and correlating a size of the fiducial markers 22 to a current distance between the following vehicle 18 and the leading vehicle 16. In some embodiments, the one or more fiducial markers 22 are optional and may be omitted. In some embodiments, the following vehicle 18 also includes one or more fiducial markers 22.

As shown in FIG. 4, the leading vehicle 16 includes the rear floorboard assembly 24. The rear floorboard assembly 24 extends longitudinally rearward of the body 20 and the rear row seating 34. In this way, the rear floorboard assembly 24 is positioned at the rear-facing side of the vehicles 10. In some embodiments, the rear floorboard assembly 24 is optional and may be omitted. In some embodiments, and as shown in FIG. 4, the following vehicle 18 also includes the rear floorboard assembly 24.

As shown in FIG. 4, the leading vehicle 16 includes one or more illuminated lamps or light elements, shown as taillights 26. Each of the taillights 26 is positioned on a portion of the vehicles 10. In particular, the taillights 26 are positioned at the rear-facing side of the leading vehicle 16. As shown in FIG. 4, the taillights 26 are positioned on the body 20 of the leading vehicle 16. The taillights 26 may be used as reference points for determining a position of the leading vehicle 16 relative to the following vehicle 18 (in addition to or as an alternative to the fiducial markers 22). For example, the taillights 26 may be used as point of references in a computer vision analysis process. The position of the leading vehicle 16 relative to the following vehicle 18 may be determined based on detecting the taillights 26 and correlating a size of the taillights 26 to a current distance between the following vehicle 18 and the leading vehicle 16. In some embodiments, the following vehicle 18 also includes the taillights 26.

As shown in FIG. 4, the following vehicle 18 includes the sensors 90 (e.g., a set of sensors, a sensor array, a sensor system, etc.). The sensors 90 include various sensors positioned about the following vehicle 10 to acquire information regarding the leading vehicle 16. In an example embodiment, the sensors 90 include at least one of a camera, a radar sensor, or a LiDAR sensor. In some embodiments, the leading vehicle 16 also includes the sensors 90.

According to an exemplary embodiment, the sensors 90 are configured to acquire data (e.g., second data) regarding a position of a person, an entity, or an object, such as the leading vehicle 16. In an example embodiment, the acquired data includes an image including one or more physical identifiers of the leading vehicle 16 (e.g., the fiducial markers 22, the taillights 26, the configuration of the leading vehicle 16, etc.). In another example embodiment, the acquired data includes LiDAR or radar data regarding the leading vehicle 16 including one or more physical identifier of the leading vehicle 16 (e.g., the configuration of the leading vehicle 16).

As shown in FIG. 4, the leading vehicle 16 includes a global positioning system (GPS) 92. The GPS 92 of the leading vehicle 16 is configured to acquire first GPS data associated with the leading vehicle 16. In particular, the first GPS data includes information regarding a location of the leading vehicle 16.

As shown in FIG. 4, the following vehicle 18 includes the GPS 92. The GPS 92 of the following vehicle 18 is configured to acquire second GPS data associated with the following vehicle 18. In particular, the second GPS data includes information regarding a location of the following vehicle 18.

As shown in FIG. 4, the leading vehicle 16 includes the vehicle control system 100. The vehicle control system 100 shown in FIG. 4 is substantially similar to or the same as the vehicle control system 100 shown in FIGS. 1 and 2. For example, the vehicle control system 100 includes the communications interface 106. The communications interface 106 facilitates communicably coupling the vehicle control system 100 to a vehicle control system of the following vehicle 18 by forming a communication connection. In some embodiments, the communication connection is a network connection that is established via the communications network 210. In other embodiments, the communication connection is a short-ranged communication connection that is established via Bluetooth®, near field communication (NFC), or other suitable short-range communication. In some embodiments, the communication interface 106 facilitates communicably coupling the vehicle control system 100 of the leading vehicle 16 to the remote systems 240 via the communications network 210. For example, the communication interfaces 106 may communicably couple the vehicle control system 100 of the leading vehicle 16 to the communication interface 256 of the off-site server 250 and/or the communication interface 266 of the on-site system 260 via the communications network 210.

As shown in FIG. 4, the following vehicle 18 includes the vehicle control system 100. The vehicle control system 100 shown in FIG. 4 is substantially similar to or the same as the vehicle control system 100 shown in FIGS. 1 and 2. For example, the vehicle control system 100 includes the communications interface 106. The communications interface 106 facilitates communicably coupling the vehicle control system 100 of the following vehicle 18 to a vehicle control system of the leading vehicle 16 by forming a communication connection. In some embodiments, the communication connection is a network connection that is established via the communications network 210. In other embodiments, the communication connection is a short-ranged communication connection that is established via Bluetooth®, near field communication (NFC), or other suitable short-range communication. The communication interface 106 facilitates communicably coupling the vehicle control system 100 of the following vehicle 18 to the remote systems 240 via the communications network 210. For example, the communication interfaces 106 may communicably couple the vehicle control system 100 of the following vehicle 18 to the communication interface 256 of the off-site server 250 and/or the communication interface 266 of the on-site system 260 via the communications network 210.

According to an exemplary embodiment, one or more of the communication interfaces, such as the communication interface 106 of the leading vehicle 16, the communication interface 106 of the following vehicle 18, the communication interface 256 of the off-site server 250, and/or the communication interface 266 of the on-site system 260 are configured to acquire data (e.g., first data). In some embodiments, the first data includes a connection strength of a short-range communication between the leading vehicle 16 and the following vehicle 18. The connection strength of the short-range communication may be indicative of a current distance between the between the leading vehicle 16 and the following vehicle 18.

In some embodiments, the first data includes the first GPS data associated with the leading vehicle 16 and the second GPS data associated with the following vehicle 18. In some embodiments, the first GPS data is acquired from the GPS 92 of the leading vehicle 16. In some embodiments, the first GPS data is acquired by the communications interface 106 of the following vehicle 18 from the leading vehicle 16. In some embodiments, the first GPS data is acquired by the communication interface 256 of the off-site server 250 and/or the communication interface 266 of the on-site system 260 from the leading vehicle 16. In some embodiments, the second GPS data is acquired from the GPS 92 of the following vehicle 18. In some embodiments, the second GPS data is acquired by the communications interface 106 of the leading vehicle 16 from the following vehicle 18. In some embodiments, the second GPS data is acquired by the communication interface 256 of the off-site server 250 and/or the communication interface 266 of the on-site system 260 from the following vehicle 18.

In some embodiments, the first data includes a path of the leading vehicle 16. The path includes, for example, a road, a street, or other terrain that the leading vehicle 16 traverses. In some embodiments, the first data includes information regarding the path such as a road name, a street name, turn-by-turn directions, GPS locations of the path, and so on.

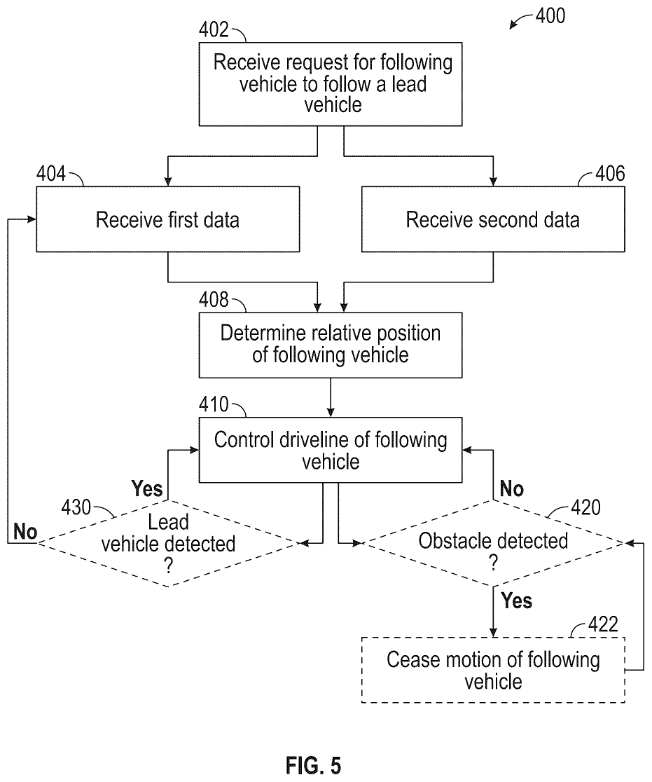

As shown in FIG. 5, a flow diagram of a method 400 is shown. The method 400 is performed by a computing system, such as one or more vehicle control systems 100 and/or one or more remote systems 240. For example, the method 400 may be performed by the vehicle control system 100 of the leading vehicle 16, the vehicle control system 100 of the following vehicle 18, the off-site server 250, and/or the on-site system 260. It should be understood that the order of the method 400 is shown as an example only. That is, one or more processes may be performed concurrently, partially concurrently, sequentially, and/or in a different order than as shown in FIG. 4. Additionally, certain processes of the method 400 may be combined or deleted/omitted.

At process 402, a request for the following vehicle 18 to follow the leading vehicle 16 is received. In some embodiments, the request is received in response to a user input at an operator interface 48. For example, the request may be received in response to a user input at the operator interface 48 of at least one of the leading vehicle 16 or the following vehicle 18.

In some embodiments, the request includes information regarding a physical identifier associated with the leading vehicle 16. For example, the information regarding the physical identifier associated with the leading vehicle 16 may include information regarding a physical configuration of the leading vehicle 16, information regarding the one or more fiducial markers 22 of the leading vehicle 16, and/or information regarding the taillights 26 of the leading vehicle 16.

In some embodiments, the request includes a command for the leading vehicle 16 and the following vehicle 18 to form a short-range communication connection. For example, the communication interface 106 of the leading vehicle 16 and the communication interface 106 of the following vehicle 18 may form a short-range communication connection therebetween.

In some embodiments, the request may be a part of a larger request involving more than two vehicles. For example, the larger request may include a first request and a second request. As part of the first request, a first vehicle is designated as a leading vehicle and a second vehicle is designated as a following vehicle. As part of the second request, the second vehicle is designated as the leading vehicle and a third vehicle is designated as the following vehicle. In this way, the method 400 may apply to a set of vehicles including multiple leading vehicles 16 and multiple following vehicles 18, where a single vehicle may be designated as a leading vehicle, a following vehicle, or both (e.g., to form a train of vehicles).

At process 404, first data is received. In some embodiments, the first data is acquired from at least one of a communications interface (e.g., the communication interface 106 of the leading vehicle 16, the communication interface of the following vehicle 18, the communication interface 256, or the communication interface 266) or from a GPS (e.g., the GPS 92 of the leading vehicle 16 or the GPS 92 of the following vehicle 18). In some embodiments, process 404 is repeated concurrently or partially concurrently with the other processes of the method 400, such that the first data is repeatedly received (e.g., in real-time or at a predefined frequency). In other embodiments, process 404 is optional and may be omitted.

In some embodiments, the first data is acquired in response to the request received at process 402. In some embodiments, the first data is acquired in response to process 430, as described herein below.

In some embodiments, when the first data is acquired by the communications interface (e.g., at least one of the communication interface 106 of the leading vehicle 16, the communication interface of the following vehicle 18, the communication interface 256, or the communication interface 266), the first data includes a connection strength of a short-range communication (e.g., the short-range communication between the communication interface 106 of the leading vehicle 16 and the communication interface of the following vehicle 18). The connection strength of the short-range communication is indicative of a current distance between the between the leading vehicle 16 and the following vehicle 18.

In some embodiments, the first data includes first GPS data associated with the leading vehicle and second GPS data associated with the following vehicle. In some embodiments, the first GPS data is acquired by at least one of the GPS 92 of the leading vehicle or the communication interface 106 of the following vehicle 18. In other embodiments, the first GPS data is acquired by at least one of the communication interface 256 or the communication interface 266.

In some embodiments, the first data includes a path of the leading vehicle 18. The path of the leading vehicle 18 is acquired by at least one of the communication interface of the following vehicle 18, the communication interface 256, or the communication interface 266.

At process 406, second data is received. The second data is acquired by a sensor system, such as the sensors 90 of the following vehicle 18. In some embodiments, process 406 is repeated concurrently or partially concurrently with the other processes of the method 400, such that the second data is repeatedly received (e.g., in real-time or at a predefined frequency). In other embodiments, process 406 is optional and may be omitted. In some embodiments, the second data is acquired in response to the request received at process 402.

The second data includes information regarding a position of the leading vehicle 16. For example, the second data may include an image captured by a camera including the physical identifier of the leading vehicle 16. In another example, the second data may include LiDAR or radar data regarding the leading vehicle 16.

In a first example embodiment, when the method 400 is performed by the vehicle control system 100 of the leading vehicle 16, the vehicle control system 100 of the leading vehicle 16 receives the second data acquired by the sensors 90 of the following vehicle 18. In a second example embodiment, when the method 400 is performed by the vehicle control system 100 of the following vehicle 18, the vehicle control system 100 of the following vehicle 18 receives the second data acquired by the sensors 90 of the following vehicle 18. In a third example embodiment, when the method 400 is performed by the off-site server 250 and/or the on-site system 260, the off-site server 250 and/or the on-site system 260 receives the second data acquired by the sensors 90 of the following vehicle 18.

At process 408, a position of the following vehicle 18 relative to the leading vehicle 16 is determined. In particular, the position of the following vehicle 18 relative to the leading vehicle 16 is determined based on at least one of the first data or the second data. The position of the following vehicle 18 relative to the leading vehicle 16 is based on at least one of a current distance between the leading vehicle 16 and the following vehicle 18, an orientation of the following vehicle 18, or an orientation of the leading vehicle 16.

In some embodiments, the position of the following vehicle 18 relative to the leading vehicle 16 is determined based on the first data. As described above, in some embodiments, the first data includes a connection strength of the short-range communication that is indicative of the current distance between the between the following vehicle 18 and the leading vehicle 16. That is, the current distance between the between the following vehicle 18 and the leading vehicle 16 is determined based on the connection strength of the short-range communication. In these embodiments, the position of the following vehicle 18 relative to the leading vehicle 16 is determined based on connection strength of the short-range communication.

In some embodiments, the position of the following vehicle 18 relative to the leading vehicle 16 is determined based on the first data. As described above, in some embodiments, the first data includes first GPS data associated with the leading vehicle 16 and second GPS data associated with the following vehicle 18. The current distance between the between the following vehicle 18 and the leading vehicle 16 is determined based on comparing the first GPS data to the second GPS data. For example, a first set of coordinates of the first GPS data are compared to a second set of coordinates of the second GPS data to determine at least one of the current distance between the leading vehicle 16 and the following vehicle 18, the orientation of the following vehicle 18, or the orientation of the leading vehicle 16.

In some embodiments, the position of the following vehicle 18 relative to the leading vehicle 16 is determined based on the second data. As described above, a physical identifier associated with the leading vehicle 16 is detected from the second data. A size of the physical identifier is correlated to the current distance between the following vehicle and the leading vehicle. For example, an image including the physical identifier may be analyzed using a computer vision analysis process that correlates the size of the physical identifier in the image to at least one of the current distance between the following vehicle 18 and the leading vehicle 16 and the lead vehicle, the orientation of the following vehicle 18, or the orientation of the leading vehicle 16. In some embodiments, the second data includes LiDAR or radar data regarding the leading vehicle 16. In these embodiments, the LiDAR or radar data is analyzed to determine at least one of the current distance between the following vehicle 18 and the lead vehicle 16, the orientation of the following vehicle 18, or the orientation of the leading vehicle 16.

At process 410, the driveline 50 of the following vehicle 18 is controlled. More specifically, the driveline 50 of the following vehicle 18 is controlled such that the following vehicle 18 autonomously follows the leading vehicle 16 within a specified distance based on at least one of the first data or the second data (e.g., without requiring a tow bar, without requiring an operator in the following vehicle 18, etc.). That is, the specified distance is maintained or attempted to be maintained based on at least one of the first data or second data. By way of example, the specified distance may be maintained based on the current distance between the following vehicle 18 and the leading vehicle 16, as determined at process 408.

In some embodiments, the driveline 50 of the following vehicle 18 is controlled such that the following vehicle 18 follows the leading vehicle 16 within the specified distance based on at least the first data. In some embodiments, the driveline 50 of the following vehicle 18 is controlled such that the following vehicle 18 follows the leading vehicle 16 within the specified distance based on at least the second data. In some embodiments, the driveline 50 of the following vehicle 18 is controlled such that the following vehicle 18 follows the leading vehicle 16 within the specified distance based on the first data and the second data.

In some embodiments, in response to the current distance between the leading vehicle 16 and the following vehicle 18 being greater than the specified distance, the driveline 50 of the following vehicle 18 is controlled to cause the following vehicle 18 to reduce the current distance. In response to the current distance between the leading vehicle 16 and the following vehicle 18 being less than the specified distance, the driveline 50 of the following vehicle 18 is controlled to cause the following vehicle 18 to increase the current distance.

In some embodiments, in response to the current distance being above the specified distance, controlling the driveline 50 such that the following vehicle 18 follows the leading vehicle 16 within the specified includes causing the prime mover 52 to increase a speed of the following vehicle 18 and/or cause the braking system 70 to refrain from braking when the leading vehicle 16 slows down. In some embodiments, in response to the current distance being below the specified distance, controlling the driveline 50 such that the following vehicle 18 follows the leading vehicle 16 within the specified includes causing the prime mover 52 to decrease the speed of the following vehicle 18 (e.g., stop accelerating, regenerative braking, etc.) or engaging the braking system 70 to decrease the speed of the following vehicle 18.

In some embodiments, controlling the driveline 50 of the following vehicle 18 such that the following vehicle 18 follows the leading vehicle 16 within the specified distance based on the first data includes causing the following vehicle 18 to follow the path of the leading vehicle 16.

In some embodiments, the driveline 50 is controlled using an automated driving system. The automated driving system may be configured to implement control of the components of the driveline 50, without operator input. However, in contrast with a fully autonomous or nearly autonomous driving vehicle, the control of the driveline 50 is configured follow the leading vehicle 18 based on the first data and/or the second data.

After process 410, the method 400 may proceed to process 420, process 430, or both. The method 400 includes, at process 420, determining whether an obstacle between the leading vehicle 16 and the following vehicle 18 is detected based on the second data. That is, in response to acquiring the second data (e.g., at process 406), the obstacle between the leading vehicle 16 and the following vehicle 18 is detected, if the obstacle is present. By way of example, the obstacle may include an object, a person, or other entity that is positioned between the leading vehicle 16 and the following vehicle 18. The following vehicle 18 may not be able to follow the leading vehicle 16 without colliding with the obstacle. In response to detecting the obstacle, the method 400 proceeds to process 422. In response to not detecting the obstacle, the method 400 returns to process 410. In other embodiments, in response to not detecting the obstacle, the method 400 proceeds to process 430. In yet other embodiments, the method 400 may proceed to process 410 and process 430 concurrently or partially concurrently.

At process 422, the braking system 70 of the following vehicle 18 and/or the prime mover 52 are controlled to cease motion of the following vehicle 18. In this way, collision between the following vehicle 18 and the obstacle may be mitigated. After process 422, the method 400 may return to process 420.

The method 400 includes, at process 430, determining whether the leading vehicle 16 is detectable based on the second data. That is, in response to acquiring the second data (e.g., at process 406), the leading vehicle 16 is detected, if the leading vehicle 16 is detectable by the sensors 90 of the following vehicle 18. By way of example, detecting the leading vehicle 16 may include capturing an image that includes the physical identifier of the leading vehicle 16 and/or acquiring LiDAR or RADAR data regarding the leading vehicle 16. In response to determining that the leading vehicle 16 is detectable based on the second data, the method 400 returns to process 410. In response to determining that the leading vehicle 16 is not detectable based on the second data, the method 400 returns to process 404. When the method 400 returns to process 404 after process 430, process 408 and process 410 may be performed using the first data and without using the second data.

In some embodiments, when the method 400 returns to process 404, in response to determining that the leading vehicle 16 is not detectable with the sensors 90 based on the second data, process 404 includes acquiring the first data. The method 400 the proceeds to process 408 and process 410 using only the first data. That is, in response to determining that the leading vehicle 16 is not detectable with the sensors 90 based on the second data, process 410 includes controlling the driveline 50 such that the following vehicle 18 follows the leading vehicle 16 within the specified distance is based on the first data.

In some embodiments, when the method 400 returns to process 410, in response to determining that the leading vehicle 16 is subsequently detectable with the sensors 90 based on the second data (after not detecting the leading vehicle 16), process 410 includes controlling the driveline 50 such that the following vehicle 18 follows the leading vehicle 16 within the specified distance based on the second data (and, in some embodiments, the first data).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle following system comprising:
a following golf vehicle including:
a driveline including a prime mover, a braking system, and a steering system;
a communications interface; and
a sensor system including one or more sensors configured to acquire second data; and
at least one processing circuit having at least one processor and at least one memory, the at least one memory storing instructions thereon that, when executed by the at least one processor, cause the at least one processor to:
receive a request for the following golf vehicle to follow a leading golf vehicle; and
control the driveline such that the following golf vehicle follows the leading golf vehicle within a specified distance based on at least one of (a) first data acquired from at least one of the communications interface or from a global positioning system (GPS) or (b) the second data acquired by the sensor system.

2. The golf vehicle following system of claim 1, wherein the request is received responsive to a user input at an operator interface of at least one of the leading golf vehicle or the following golf vehicle.

3. The golf vehicle following system of claim 1, wherein the instructions cause the at least one processor to control the driveline such that the following golf vehicle follows the leading golf vehicle within the specified distance based on the first data and the second data.

4. The golf vehicle following system of claim 1, wherein the at least one processing circuit includes a first processing circuit located on the following golf vehicle and a second processing circuit located remote from the following golf vehicle.

5. The golf vehicle following system of claim 1, wherein the at least one processing circuit is located on the following golf vehicle.

6. The golf vehicle following system of claim 1, wherein the request includes a command for the leading golf vehicle and the following golf vehicle to form a short-range communication connection.

7. The golf vehicle following system of claim 6, wherein the first data is acquired from the communications interface, wherein the first data includes a connection strength of the short-range communication indicative of a current distance between the between the following golf vehicle and the leading golf vehicle, and wherein the instructions cause the at least one processor to:
responsive to the current distance being greater than the specified distance, control the driveline to cause the following golf vehicle to reduce the current distance; and
responsive to the current distance being less than the specified distance, control the driveline to cause the following golf vehicle to increase the current distance.

8. The golf vehicle following system of claim 1, wherein the instructions cause the at least one processor to:
acquire the second data in response to the request; and
control the driveline such that the following golf vehicle follows the leading golf vehicle within the specified distance based at least on the second data.

9. The golf vehicle following system of claim 8, wherein the one or more sensors of the sensor system include at least one of a camera, a LiDAR sensor, or a radar sensor.

10. The golf vehicle following system of claim 8, wherein the instructions cause the at least one processor to:
detect a physical identifier associated with the leading golf vehicle from the second data;
correlate a size of the physical identifier to a current distance between the following golf vehicle and the leading golf vehicle;
responsive to the current distance being greater than the specified distance, control the driveline to cause the following golf vehicle to reduce the current distance; and
responsive to the current distance being less than the specified distance, control the driveline to cause the following golf vehicle to increase the current distance.

11. The golf vehicle following system of claim 10, wherein the physical identifier includes at least one of:
a configuration of the leading golf vehicle;
one or more taillights of the leading golf vehicle; or
one or more fiducial markers positioned on the leading golf vehicle.

12. The golf vehicle following system of claim 1, wherein the instructions cause the at least one processor to:
acquire the first data in response to the request; and
control the driveline such that the following golf vehicle follows the leading golf vehicle within the specified distance based at least on the first data.

13. The golf vehicle following system of claim 1, wherein:
the first data includes first GPS data associated with the leading golf vehicle and second GPS data associated with the following golf vehicle;
the instructions cause the at least one processor to compare the first GPS data to the second GPS data associated with the following golf vehicle to determine a current distance between the following golf vehicle and the leading golf vehicle; and
controlling the driveline such that the following golf vehicle follows the leading golf vehicle within the specified distance includes:
responsive to the current distance being above the specified distance, causing the prime mover to increase a speed of the following golf vehicle; and
responsive to the current distance being below the specified distance, causing the prime mover to decrease the speed of the following golf vehicle.

14. The golf vehicle following system of claim 13, wherein the first GPS data is acquired by the communications interface from the leading golf vehicle.

15. The golf vehicle following system of claim 13, wherein the first GPS data is acquired from the GPS.

16. The golf vehicle following system of claim 1, wherein:
the first data includes a path of the leading golf vehicle; and
controlling the driveline such that the following golf vehicle follows the leading golf vehicle within the specified distance based on the first data includes causing the following golf vehicle to follow the path of the leading golf vehicle.

17. The golf vehicle following system of claim 1, wherein the instructions cause the at least one processor to:
acquire the second data;
detect, based on the second data, an obstacle between the leading golf vehicle and the following golf vehicle;
control the braking system to cease motion of the following golf vehicle;
responsive to determining that the obstacle is no longer detected by the sensor system based on the second data, determine whether the leading golf vehicle is detectable with the sensor system based on the second data;
control the driveline such that the following golf vehicle follows the leading golf vehicle within the specified distance based on the second data in response to determining that the leading golf vehicle is detectable by the sensor system;
acquire the first data in response to determining that the leading golf vehicle is not detectable with the sensor system; and
control the driveline such that the following golf vehicle follows the leading golf vehicle within the specified distance based on the first data.

18. The golf vehicle following system of claim 1, wherein the instructions cause the at least one processor to:
acquire the second data;
determine that the leading golf vehicle is not detectable with the sensor system based on the second data;
acquire the first data in response to determining that the leading golf vehicle is not detectable with the sensor system; and
control the driveline such that the following golf vehicle follows the leading golf vehicle within the specified distance based on the first data.

19. A vehicle following system comprising:
a non-transitory computer readable media storing instructions that, when executed by one or more processors of a processing circuit, cause the processing circuit to perform operations comprising:
receiving a request for a following vehicle to follow a leading golf vehicle;
receiving at least one of (a) first data acquired from at least one of a communications interface or a global positioning system (GPS) or (b) second data acquired by a sensor system of the following vehicle; and
controlling a driveline of the following vehicle such that the following vehicle follows the leading vehicle within a specified distance based on at least one of the first data or the second data.

20. A vehicle following system comprising:
a following vehicle including:
a driveline including a prime mover, a braking system, and a steering system;
a communications interface; and
a sensor system including one or more sensors configured to acquire second data; and
at least one processing circuit having at least one processor and at least one memory, the at least one memory storing instructions thereon that, when executed by the at least one processor, cause the at least one processor to:
receive a request for the following vehicle to follow a leading vehicle; and
control the driveline such that the following vehicle follows the leading vehicle within a specified distance based on at least one of (a) first data acquired from at least one of the communications interface or from a global positioning system (GPS) or (b) the second data acquired by the sensor system.
